(19) United States
(12) Patent Application Publication
(10) Pub. No.: US 2026/0015534 A1
(43) Pub. Date: Jan. 15, 2026

(54) A RECYCLABLE EPOXY ADHESIVE SYSTEM

(71) Applicant: ADITYA BIRLA CHEMICALS (THAILAND) LIMITED (ADVANCED MATERIALS), MAP TA PHUT, RAYONG (TH)

(72) Inventors: Pradip Kumar DUBEY, MAP TA PHUT, RAYONG (TH); Amit DIXIT, MAP TA PHUT, RAYONG (TH); Kanchana INCHAMNAN, MAP TA PHUT, RAYONG (TH); Pafun JANPOUNG, MAP TA PHUT, RAYONG (TH)

(21) Appl. No.: 19/138,407

(22) PCT Filed: Dec. 12, 2023
(86) PCT No.: PCT/IB2023/062518

§ 371 Date: Jun. 12, 2025

(30) Foreign Application Priority Data
Dec. 12, 2022 (IN) 202211071474

(51) Int. Cl. C09J 163/00

(52) U.S. Cl. CPC C09J 163/00

(57) ABSTRACT

A recyclable epoxy adhesive system is disclosed. The recyclable epoxy adhesive system comprises 60-80% by wt. of an epoxy resin component having one or more di-functional epoxy resin; and 20-40% by wt. of a curing agent component having one or more curing agent having at least one cleavable linkage.

### TECHNICAL FIELD

The present disclosure relates to epoxy adhesive systems. Specifically, the disclosure relates to recyclable epoxy adhesive systems, methods for preparing such systems and the applications of such systems.

### BACKGROUND

Epoxy adhesive systems are widely used in consumer, industrial and structural bonding applications on account of their ease of processing, user friendliness and high mechanical and adhesion strength. In demanding applications such as wind turbine blades epoxy adhesives are used for joining two halves of the blade as they are highly resilient and enable exceptional fatigue behavior in both static as well as dynamic loading conditions. The conventional epoxy adhesives are non-recyclable due to inherent nature of epoxy thermosets. The non-recyclability creates a constraint in recycling and debonding of adhesive joint.

### SUMMARY

The present disclosure relates to a recyclable epoxy adhesive system. The recyclable epoxy adhesive system comprises 60-80% by wt. of an epoxy resin component having one or more di-functional epoxy resin: and 20-40% by wt. of a curing agent component having one or more curing agent having at least one cleavable linkage.

### BRIEF DESCRIPTION OF DRAWINGS

FIG. 1 depicts debonding by solvolysis of an adhesive joint made by using an epoxy adhesive system (System 3) prepared in accordance with an embodiment of the present disclosure.

FIG. 2 depicts neutralization of solvolysis solution and recovery of System 3 after the debonding.

FIG. 3A and 3B provide cross-sectional views of Specimen 1 and Specimen 2 respectively after thermal crack resistance test.

FIG. 3C and 3D provide front views of Specimen 1 and Specimen 2 respectively after the thermal crack resistance test.

FIG. 3E and 3F provide rear views of Specimen 1 and Specimen 2 respectively after the thermal crack resistance test.

FIG. 4A and 4B are pictures of Panel 1 and Panel 2 respectively after the curing shrinkage test.

FIG. 5 depicts the exothermic profiles of the conventional system and System 3.

### DETAILED DESCRIPTION

Reference will now be made in detail to embodiments of the present disclosure. The terminology used in the description presented herein is not intended to be interpreted in any limited or restrictive manner, simply because it is being utilized in conjunction with a detailed description of certain specific embodiments of the invention. Furthermore, embodiments of the invention may include several features, no single one of which is solely responsible for its desirable attributes, or which is essential to practicing the inventions herein described.

It will be understood by those skilled in the art that the foregoing general description and the following detailed description are explanatory of the invention and are not intended to be restrictive thereof.

The terms “a,” “an,”, and “the” are used to refer to “one or more” (i.e., to at least one) of the grammatical object of the article. Reference throughout this specification to “an aspect”, “another aspect” or similar language means that a particular feature, structure, or characteristic described in connection with the embodiment is included in at least one embodiment of the present invention.

The terms “comprise”, “comprising”, or any other variations thereof, are intended to cover a non-exclusive inclusion and are not intended to be construed as “consists of only”, such that a process or method that comprises a list of steps does not include only those steps but may include other steps not expressly listed or inherent to such process or method.

Likewise, the terms “having” and “including”, and their grammatical variants are intended to be non-limiting, such that recitations of said items in a list are not to the exclusion of other items that can be substituted or added to the listed items.

Unless defined otherwise, all technical and scientific terms used herein have the same meaning as commonly understood by one of ordinary skill in the art to which this disclosure belongs. Although any methods and materials similar or equivalent to those described herein can be used in the practice or testing of the disclosure, the preferred methods, and materials are now described. All publications mentioned herein are incorporated herein by reference.

The present disclosure in general relates to epoxy adhesive systems. Particularly, the present disclosure relates to recyclable epoxy adhesive systems.

The term “recyclable epoxy adhesive system” in the context of the present disclosure means a system in which the cross linked network structure is capable of disintegrating in the presence of heat and an acid, resulting in the recovery of the epoxy adhesive system.

The disclosed recyclable epoxy adhesive systems comprise an epoxy resin component and a curing agent component comprising one or more curing agent having at least one cleavable linkage.

The recyclable epoxy adhesive systems according to the present disclosure comprise 60-80% by wt. of an epoxy resin component having one or more di-functional epoxy resin and 20-40% by wt. of a curing agent component having one or more curing agent having at least one cleavable linkage.

In accordance with an embodiment, the one or more di-functional epoxy resin is in the range of 65-85% by wt. of the total weight of the epoxy resin component.

In accordance with some embodiments, the one or more di-functional epoxy resin(s) is selected from the group consisting of Bisphenol A epoxy resin, Bisphenol F epoxy resin and a combination thereof.

In accordance with various embodiments, the epoxy resin component comprises mono or di-functional epoxidized reactive diluents selected from the group consisting of aliphatic epoxidized reactive diluents, aromatic epoxidized reactive diluents, non-reactive diluents, and a combination thereof. In specific embodiments, the diluent is selected from the group consisting of 1,4 butane diol diglycidyl ether, C 12-14 alkyl glycidyl ether, 1,6-hexanediol diglycidyl ether, cresyl glycidyl ether, polypropylene glycol and a combination thereof.

The cleavable linkage is disintegrated upon exposure to elevated temperature in an acidic medium. In accordance with an embodiment, the curing agent includes a cleavable linkage selected from an acetal linkage, a ketal linkage, a formal linkage, an orthoester, orthocarbonate linkage, and a siloxy linkage. In a specific embodiments, the curing agent is from the Recyclamine® curing agent platform. In accordance with some embodiments, the curing agent is selected from an adduct of 2,2′ bis (2-aminoethoxy) propane, 2,2′ (2-aminopropoxy) propane, and 2,2′ bis (2 amino butoxy) methyl silane. In accordance with an embodiment, the curing agent is in a range of 70-90% by wt. of the total weight of the curing agent component.

The recyclable epoxy adhesive system may contain one or more additional components. The selection of the additional components is based on attributes or characteristics required in the epoxy adhesive system and the end-use or the intended application of the epoxy adhesive system. Examples of such components include but are not limited to one or more of an additive, a modifier, an accelerator, and a combination thereof.

The one or more of an additional component may be added as a separate component in addition to the epoxy resin component and the curing agent component. Alternatively, said one or more of an additional components is part of the epoxy resin component and/or the curing agent component. In accordance with an embodiment, the total amount of the one or more of an additional component in the recyclable epoxy adhesive system is in the range of 10-30% by wt. of the recyclable epoxy adhesive system.

In accordance with some embodiments, the one or more of an additive is fumed silica, one or more pigment, one or more natural fiber, milled glass, carbon fiber, and a combination thereof.

In accordance with some embodiments, the one or more of a modifier is one or more of a toughener, a defoamer, a coupling agent, a flow additive, a rheological additive, a filler, an air release additive, a wetting agent, a coupling agent, or a combination thereof. Examples of the modifier include but are not limited to core shell rubber toughener, block copolymer, activated clay, silicone defoamer, epoxy silane, amino silanes, and a combination thereof.

In accordance with an embodiment, the recyclable epoxy adhesive system comprises one or more accelerator. In a specific embodiment, the accelerator is an alkyl alkanolamine or its derivative.

The present disclosure also relates to a method of making the above disclosed recyclable epoxy adhesive system. The method comprises mixing the epoxy resin component and the curing agent component. Any known method may be used for the mixing. For example, the mixing can be performed by magnetic stirrers, hands, static mixers, or any other suitable equipment.

The present disclosure also relates to an adhesive joint prepared using the above disclosed recyclable epoxy adhesive system. The adhesive joint can be recycled and de-bonded by low energy solvolysis process. In accordance with an embodiment, the adhesive joint comprises two or more Glass Reinforced Epoxy (GRE) substrates joined to each other by the above disclosed recyclable epoxy adhesive system.

The disclosed invention will be now illustrated by means of the following examples. The examples are intended to illustrate various embodiments of the invention and are not meant to limit the scope of the claimed invention. Those skilled in the art will recognize that variations and modifications may be made to the described embodiments without departing from the broader scope and spirit of the invention as set forth in the claims.

### EXAMPLES

### Examples 1: Preparation of Recyclable Epoxy Adhesive Systems 1-13 in Accordance with Various Embodiments of the Present Disclosure

Procedure: Epoxy adhesive Systems 1-13 were prepared using an epoxy resin component composition as provided in Tables 1A and 1B and a curing agent component composition as provided in Table 2A and 2B. The ratio of epoxy resin component to the curing agent component (parts by weight) in each System is provided in Table 3. The epoxy resin component and the curing agent component were mixed in stoichiometric ratios to react and crosslink, cure and obtain Systems 1-13.

TABLE 1A
The Epoxy Component Composition (Systems 1-7)

| | System | | | | | | |
|---|---|---|---|---|---|---|---|
| Ingredient | 1 | 2 | 3 | 4 | 5 | 6 | 7 |
| Bisphenol A Diglycidyl Ether (% by wt.) | 84 | 85 | 76 | 77 | 66 | 76 | 76 |
| Bisphenol F Diglycidyl Ether (% by wt.) | — | — | — | — | — | — | — |
| Mono Glycidyl Ether of C12-C14 Alcohol | — | — | 5 | 4 | 4 | 5 | 5 |
| (% by wt.) | | | | | | | |
| Diglycidyl Ether of 1,4 Butane Diol (% by wt.) | — | — | — | — | — | — | — |
| Mono Glycidyl Ether of Ortho Cresyl (% by wt.) | — | — | — | — | — | — | — |
| Diglycidyl Ether of 1,6 Hexane Diol (% by wt.) | — | — | — | — | — | — | — |
| Polypropylene Glycol | — | — | — | — | — | — | — |
| (% by wt.) | | | | | | | |
| Hydrophobic pyrogenic silica (% by wt.) | 7 | 4 | 5 | 5 | 5 | 5 | 5 |
| Cotton Cellulose | 4 | 4 | 4 | 4 | — | 4 | 4 |
| (% by wt.) | | | | | | | |
| Milled Glass fiber | — | — | — | — | 20 | — | — |
| (% by wt.) | | | | | | | |
| Methyl Methacrylate - Butadiene - Styrene Core Shell, | — | 10 | 10 | 10 | 5 | 10 | 10 |
| Avg. Particle size <200 nm | | | | | | | |
| Silicone Block Copolymer with Organic Block | 5 | — | — | — | — | — | — |

TABLE 1B
The Epoxy Component Composition (Systems 8-13)

| | System | | | | | |
|---|---|---|---|---|---|---|
| Ingredient | 8 | 9 | 10 | 11 | 12 | 13 |
| Bisphenol A Diglycidyl Ether (% by wt.) | 76 | 55 | 76 | 76 | 76 | 76 |
| Bisphenol F Diglycidyl Ether (% by wt.) | — | 18 | — | — | — | — |
| Mono Glycidyl Ether of C12-C14 Alcohol | 5 | 5 | — | — | — | — |
| (% by wt.) | | | | | | |
| Diglycidyl Ether of 1,4 Butane Diol (% by wt.) | — | — | 5 | — | — | — |
| Mono Glycidyl Ether of Ortho Cresyl (% by wt.) | — | — | — | 5 | — | — |
| Diglycidyl Ether of 1,6 Hexane Diol (% by wt.) | — | — | — | — | 5 | — |
| Polypropylene Glycol | — | — | — | — | — | 5 |
| (% by wt.) | | | | | | |
| Hydrophobic pyrogenic silica (% by wt.) | 5 | 8 | 5 | 5 | 5 | 5 |
| Cotton Cellulose | 4 | 4 | 4 | 4 | 4 | 4 |
| (% by wt.) | | | | | | |
| Milled Glass fiber | — | — | — | — | — | — |
| (% by wt.) | | | | | | |
| Methyl Methacrylate - Butadiene - Styrene Core Shell, Avg. | 10 | 10 | 10 | 10 | 10 | 10 |
| Particle size <200 nm | | | | | | |
| Silicone Block Copolymer with Organic Block | — | — | — | — | — | — |

TABLE 2A
The Curing Agent Component Composition (System 1-7)

| | System | | | | | | |
|---|---|---|---|---|---|---|---|
| Ingredient | 1 | 2 | 3 | 4 | 5 | 6 | 7 |
| Polyamine Adduct Reaction Product of | 30.3 | — | — | — | — | — | — |
| Bisphenol A Epoxy and 2,2′ (2-Amino | | | | | | | |
| Propoxy) Propane with Ratio 20:80 (% by | | | | | | | |
| wt.) | | | | | | | |
| Polyamine Adduct as Reaction Product of | — | 35.1 | 35.1 | 35.1 | 30.3 | 31.3 | — |
| Bisphenol A Epoxy and 2,2′ (2-Amino | | | | | | | |
| Propoxy) Propane with Ratio 30:70 (% by | | | | | | | |
| wt.) | | | | | | | |
| Polyamine Adduct as Reaction Product of | — | — | — | — | — | — | 30.3 |
| Bisphenol A Epoxy and 2,2′ Bis (2- | | | | | | | |
| Aminoethyoxy) Propane with Ratio 30:70 | | | | | | | |
| (% by wt.) | | | | | | | |
| Polyamine Adduct as Reaction Product of | — | — | — | — | — | — | — |
| Bisphenol A Epoxy and 2,2′ Bis (2 Amino | | | | | | | |
| Butoxy) Methyl Silane with Ratio 30:70 (% | | | | | | | |
| by wt.) | | | | | | | |
| Poly Oxypropylene Triamine (% by wt.) | — | — | 4 | 4 | 3 | 3 | 3 |
| Fumed Silica (% by wt.) | 2 | 2 | 2 | 2.5 | 2 | 2.5 | 2 |
| Activated Clay (% by wt.) | 1.7 | 1.9 | 1.9 | 1.9 | 1.7 | 1.7 | 1.7 |
| N,N Dihydroxyethyl Isopropanol Amine | — | — | — | 2.5 | — | 1.5 | 1.5 |
| (% by wt.) | | | | | | | |
| Monoethanolamine | — | — | — | — | — | 1 | 1.5 |
| (% by wt.) | | | | | | | |

TABLE 2B
The Curing Agent Component Composition (System 8-13)

| | System | | | | | |
|---|---|---|---|---|---|---|
| Ingredient | 8 | 9 | 10 | 11 | 12 | 13 |
| Polyamine Adduct Reaction Product of Bisphenol | — | — | — | — | — | — |
| A Epoxy and 2,2′ (2-Amino Propoxy) Propane | | | | | | |
| with Ratio 20:80 (% by wt.) | | | | | | |
| Polyamine Adduct as Reaction Product of | — | 34.3 | 35.9 | 35.1 | 35.1 | 33.5 |
| Bisphenol A Epoxy and 2,2′ (2-Amino Propoxy) | | | | | | |
| Propane with Ratio 30:70 (% by wt.) | | | | | | |
| Polyamine Adduct as Reaction Product of | — | — | — | — | — | — |
| Bisphenol A Epoxy and 2,2′ Bis (2-Aminoethyoxy) | | | | | | |
| Propane with Ratio 30:70 (% by wt.) | | | | | | |
| Polyamine Adduct as Reaction Product of | 35.3 | — | — | — | — | — |
| Bisphenol A Epoxy and 2,2′ Bis (2 Amino Butoxy) | | | | | | |
| Methyl Silane with Ratio 30:70 (% by wt.) | | | | | | |
| Poly Oxypropylene Triamine (% by wt.) | 3 | 3.8 | 4.2 | 4 | 4 | 3.8 |
| Fumed Silica (% by wt.) | 2.5 | 2 | 2 | 2 | 2 | 1.9 |
| Activated Clay (% by wt.) | 1.7 | 1.9 | 1.9 | 1.9 | 1.9 | 1.8 |
| N,N Dihydroxyethyl Isopropanol Amine | 1.5 | — | — | — | — | — |
| (% by wt.) | | | | | | |
| Monoethanolamine | 1 | — | — | — | — | — |
| (% by wt.) | | | | | | |

TABLE 3
Ratio (by wt) of the Epoxy Resin Component
to the Curing Agent Component

| System | Ratio |
|---|---|
| System 1 | 100:34 |
| System 2 | 100:39 |
| System 3 | 100:43 |
| System 4 | 100:46 |
| System 5 | 100:37 |
| System 6 | 100:41 |
| System 7 | 100:40 |
| System 8 | 100:45 |
| System 9 | 100:42 |
| System 10 | 100:44 |
| System 11 | 100:43 |
| System 12 | 100:43 |
| System 13 | 100:41 |

### Examples 2: Debonding by Solvolysis of Adhesive Joint Made by Using System 3

### Materials: The Following Materials Were Used:

a) System 3
b) GRE substrates of size 120×70×4 mm.

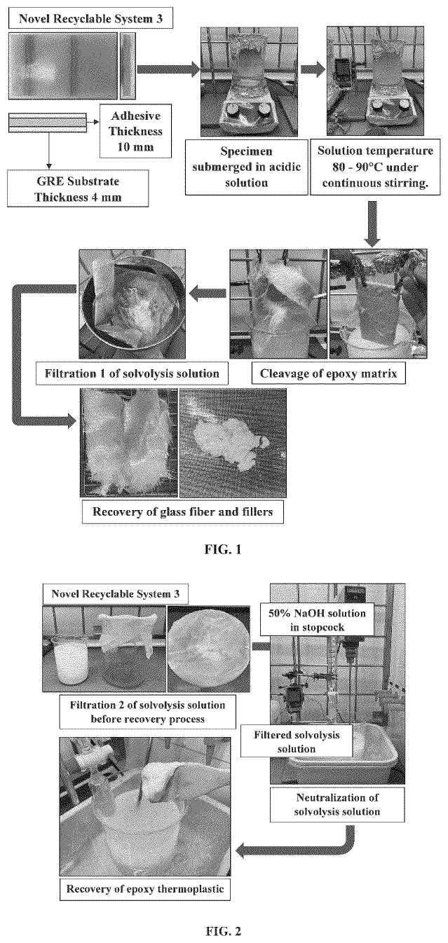

Procedure: An adhesive joint was formed by applying system 3 on the GRE substrates maintaining glue line thickness of 10 mm. The adhesive joint was subjected to debonding by solvolysis followed by neutralization of solvolysis solution and recovery of epoxy thermoplastic as depicted in FIGS. 1 and 2 respectively. Initially, the debonding of the adhesive joint and cleavage of epoxy matrix of System 3 occurred after 2 hours. The recovered glass fabric was removed and stirring was continued at 80-90° C. After 20 hours, the epoxy matrix of System 3 was completely cleaved and dissolved in solvolysis solution. After that solvolysis solution was filtered in order to separate coarse fillers (Filtration 1) and re-filtered in order to separate fine fillers (Filtration 2). Subsequently, neutralization and coagulation of the solvolysis solution was conducted using 50% NaOH surrounding the beaker by ice to control the heat of reaction. The pH of the solvolysis solution was maintained at 7 or more to ensure complete recovery of the epoxy matrix of System 3 and its conversion into epoxy thermoplastic.

Results and observation: The recycling process resulted in the recovery of glass fabric, fillers, and epoxy thermoplastic, which could be further re-used and re-purposed.

### Example 3: Evaluation of the Properties of Systems 1-13.

Procedure: Systems 1-13 obtained above were evaluated for their process and performance properties. The details of the properties evaluated, and the test method used are provided in Tables 4A, 4B, 5A, and 5B.

TABLE 4A
Processing Properties of Systems 1-7

| Processing | Test | | System | | | | | | |
|---|---|---|---|---|---|---|---|---|---|
| Properties | Method | Unit | 1 | 2 | 3 | 4 | 5 | 6 | 7 |

h@25° C., 2.5 s⁻¹

| | | | | | | | | | |
|---|---|---|---|---|---|---|---|---|---|
| The Epoxy | TEC- | Pa · s | 453 | 499 | 554 | 574 | 492 | 561 | 570 |
| Resin | AS-P- | | | | | | | | |
| Component | 090 | | | | | | | | |
| The Curing | | | 382 | 474 | 456 | 416 | 498 | 498 | 487 |
| Agent | | | | | | | | | |
| Component | | | | | | | | | |
| The | | | 358 | 286 | 275 | 263 | 291 | 315 | 295 |
| Recyclable | | | | | | | | | |
| Epoxy | | | | | | | | | |
| Adhesive | | | | | | | | | |
| System | | | | | | | | | |
| Glass | ISO | ° C. | 86.61 | 88.43 | 82.38 | 88.15 | 84.1 | 82.01 | 78.88 |
| Transition | 11357-2 | | | | | | | | |
| Temperature^{(a)} | | | | | | | | | |
| Pot life, 100 | ASTM | minutes | 122.5 | 112 | 154.5 | 95 | 158 | 56 | 23.5 |
| gms mix @ | D2471 | | | | | | | | |
| 35° C. | | | | | | | | | |

The curing condition: 60° C./1.5 hrs. +70° C./7 hrs

TABLE 4B
Processing Properties of Systems 8-13

| Processing | Test | | System | | | | | |
|---|---|---|---|---|---|---|---|---|
| Properties | Method | Unit | 8 | 9 | 10 | 11 | 12 | 13 |

Viscosity @25° C., 2.5 s⁻¹

| | | | | | | | | |
|---|---|---|---|---|---|---|---|---|
| The Epoxy Resin | TEC-AS- | Pa · s | 565 | 547 | 579 | 586 | 629 | 498 |
| Component | P-090 | | | | | | | |
| The Curing Agent | | | 498 | 477 | 468 | 471 | 464 | 456 |
| Component | | | | | | | | |
| The Recyclable Epoxy | | | 291 | 269 | 280 | 294 | 320 | 264 |
| Adhesive System | | | | | | | | |
| Glass Transition | ISO | ° C. | 80.42 | 81.53 | 87.25 | 87.95 | 84.33 | 79.81 |
| Temperature^{(a)} | 11357-2 | | | | | | | |
| Pot life, 100 gms mix @ | ASTM | minutes | 221 | 121 | 117 | 132 | 137.5 | 130 |
| 35° C. | D2471 | | | | | | | |

The curing condition: 60° C./1.5 hrs. +70° C./7 hrs

TABLE 5A
Performance Properties of Systems 1-7

| Performance | Test | | System | | | | | | |
|---|---|---|---|---|---|---|---|---|---|
| Properties | Method | Unit | 1 | 2 | 3 | 4 | 5 | 6 | 7 |
| Tensile | ISO | MPa | 62.43 | 64.3 | 52.43 | 57.2 | 71.92 | 53.06 | 50.74 |
| Strength | 527-2 | | | | | | | | |
| Fracture | | % | 3.68 | 3.14 | 3.64 | 3.77 | 2.24 | 4.41 | 4.25 |
| Strain | | | | | | | | | |
| Elongation at | | % | 3.85 | 3.23 | 6.06 | 4.32 | 2.25 | 4.83 | 3.22 |
| Break | | | | | | | | | |
| E-Modulus | | MPa | 3,346 | 3,421 | 2,847 | 2,998 | 5,219 | 2,884 | 2,952 |
| Critical | ISO | MPa · | 2.71 | 2.78 | 2.77 | 2.71 | 3.54 | 2.38 | 2.74 |
| Stress | 13586 | m^{1/2} | | | | | | | |
| Intensity | | | | | | | | | |
| Factory, K1c | | | | | | | | | |
| Critical | | J/m² | 3,139 | 3,738 | 5,327 | 3,666 | 5,051 | 3,252 | 3,514 |
| Strain Energy | | | | | | | | | |
| Release Rate, | | | | | | | | | |
| G1c | | | | | | | | | |
| Tensile Lap | ISO EN | MPa | 24.87 | 25.12 | 25.74 | 24.33 | 24.22 | 24.45 | 24.78 |
| Shear | 1465 | | | | | | | | |
| Strength | | | | | | | | | |
| (GRE-GRE) | | | | | | | | | |
| Heat | ISO | ° C. | 71.47 | 84.93 | 80.1 | 76.3 | 83.17 | 79.53 | 76.38 |
| Distortion | 75-2 | | | | | | | | |
| Temperature | | | | | | | | | |
| (HDT) | | | | | | | | | |
| Cured | ISO | gm/cm³ | 1.2 | 1.17 | 1.16 | 1.18 | 1.27 | 1.17 | 1.16 |
| Density | 1183-1 | | | | | | | | |

TABLE 5B
Performance Properties of Systems 8-13

| Performance | Test | | System | | | | | |
|---|---|---|---|---|---|---|---|---|
| Properties | Method | Unit | 8 | 9 | 10 | 11 | 12 | 13 |
| Tensile Strength | ISO 527- | MPa | 57.1 | 51.22 | 55.19 | 56.78 | 55.43 | 53.01 |
| Fracture Strain | 2 | % | 2.97 | 3.54 | 3.24 | 3.31 | 3.30 | 4.13 |
| Elongation at | | % | 3.17 | 6.14 | 5.89 | 5.99 | 5.77 | 6.87 |
| Break | | | | | | | | |
| E-Modulus | | MPa | 2,789 | 2,647 | 2,519 | 2,581 | 2,523 | 2,644 |
| Critical Stress | ISO | MPa · | 2.84 | 2.69 | 2.97 | 2.86 | 2.89 | 2.92 |
| Intensity | 13586 | m^{1/2} | | | | | | |
| Factory, K1c | | | | | | | | |
| Critical Strain | | J/m² | 2,831 | 5,215 | 5,784 | 5,766 | 5,764 | 5,541 |
| Energy Release | | | | | | | | |
| Rate, G1c | | | | | | | | |
| Tensile Lap | ISO EN | MPa | 25.10 | 24.79 | 25.56 | 25.33 | 24.87 | 25.13 |
| Shear Strength | 1465 | | | | | | | |
| (GRE-GRE) | | | | | | | | |
| Heat Distortion | ISO | ° C. | 72.14 | 78.14 | 81.78 | 82.05 | 81.33 | 77.25 |
| Temperature | 75-2 | | | | | | | |
| (HDT) | | | | | | | | |
| Cured Density | ISO | gm/cm³ | 1.17 | 1.17 | 1.17 | 1.16 | 1.17 | 1.16 |
| | 1183-1 | | | | | | | |

Results and observation: Systems 1-13 exhibited moderate to long working time. high adhesion strength. high fracture toughness and resilience.

### Example 4: Comparison of Crack Resistance of System 3 and a Conventional Non-Recyclable Epoxy Adhesive System

Materials: The following were used for carrying out the experiment:
a) System 3
b) A conventional non-recyclable epoxy adhesive system (“conventional system”) including an epoxy resin component having 80-90% by wt. Bisphenol A epoxy resin, 6-8% by wt. hydrophobic fumed silica, methyl methacrylate-butadiene-styrene core shell, 3-7% by wt. and <1% by wt. pigment, defoamers, and coupling agent, and a curing agent component having 5-10% by wt. cycloaliphatic amine, 55-65% by wt. polyether amine, 15-255% by wt. polyamide, 5-15% by wt. hydrophilic fumed silica, and <1% by wt. pigment, defoamers, and coupling agent
c) GRE substrates 1-4 having 6.5 mm thickness.

Procedure: The GRE substrates 1-4 along with the epoxy resin components and the curing agent components of the conventional system and System 3 respectively were warmed to a temperature of 45° C. The warmed epoxy resin components and the curing agent components were mixed in accordance with stoichiometric ratios to obtain the conventional system and System 3 respectively. The conventional system and System 3 were laid out with bead size 240 (L)×150 (W)×50 (T), mm on the GRE substrate 1 and 2 respectively. Both the systems were directly applied to GRE substrate 1 and 2 to form triangular shaped beads within 35minutes. Three thermocouples were installed and positioned in the middle of the beads on each of the GRE substrate 1 and 2. GRE substrates 3 and 4 was applied with force to the beads on GRE substrates 1 and 2 respectively to obtain Specimen 1 and 2. The experimental set up was moved in oven at 45° C. A temperature ramp up was started with 1° C./min rate until the temperature reached to 95° C. After that, the specimens were held at 95° C. for 100 minutes and the assembly was allowed to cure.

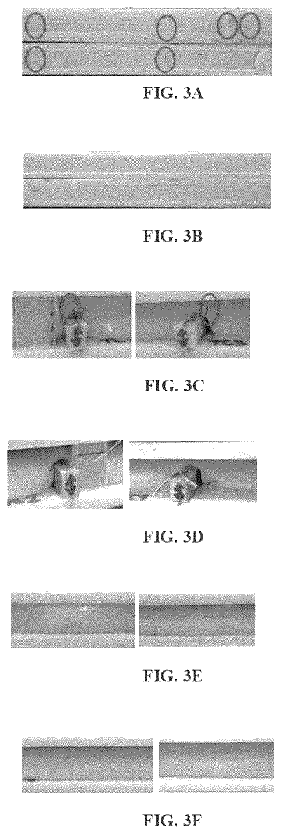

Results and observations: FIG. 3A and 3B provide cross-sectional views of Specimen 1 (having the conventional system) and Specimen 2 (having System 3) respectively after the test. FIG. 3C and 3D provide front views of Specimen 1 and Specimen 2 respectively after the test. FIG. 3E and 3F provide rear views of Specimen 1 and Specimen 2 respectively after the test. After the test Specimen 2 showed no cracks while cracks were observed in the conventional system.

### Example 5: Comparison of Curing Shrinkage of System 3 and the Conventional System

Materials: The following were used to carry out this experiment:
a) System 3
b) The conventional system
c) GRE substrate having 1.5-1.8 mm thickness and of size 300×50×1.5 mm

Procedure: The conventional system and System 3 were applied in a thickness of 10 mm on two different GRE substrates to prepare Panel 1 and 2. Panels 1 and 2 were cured at 65°° C. for 5 hours and immediately taken out and allowed to cool down at ambient temperature. The area under bending surface of panels 1-2 was calculated in mm2 to determine cure shrinkage.

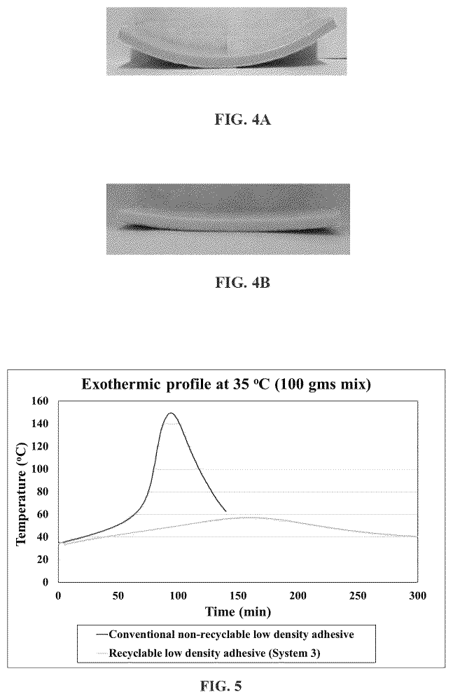

Results and observation: FIG. 4A is a picture of Panel 1 (having the conventional system) after the test. FIG. 4B is a picture of Panel 2 (having System 3) after the test. The bending indicates the extent of shrinkage. After the test the conventional system exhibited significant shrinkage while System 3 exhibited very less shrinkage.

### Example 6: Comparison of Exothermic Profiles of System 3 and the Conventional System

Procedure: The exothermic profiles of System 3 and the conventional system were compared. The epoxy resin component and the curing agent components of System 3 and the conventional system were conditioned in an incubator at 35° C. for 4 hours. The components were mixed in accordance to stoichiometric ratios to obtain System 3 and conventional system respectively. 100 gm of each system were transferred in paper cups (9 oz). A temperature recorder and a stopwatch were started after the systems were completely mixed. The paper cups were kept in the incubator at 35° C. The rise in temperature over time of System 3 and the conventional system was measured using thermocouple.

Results and observations: As can be seen in FIG. 5, the conventional system showed higher peak than System 3, which has broader peak. It also indicated that the reactivity of the conventional system was faster than System 3.

### INDUSTRIAL APPLICABILITY

The disclosed epoxy adhesive system is recyclable and therefore, can be de-bonded by recycling process to recover epoxy thermoplastic that can further be reused and repurposed. The disclosed system exhibits, lower curing shrinkage, low exothermic heat release during cure and possesses high mechanical, adhesion strength and resilience. The disclosed system exhibits high performance properties and is ideally suited for structural bonding applications. It is suitable for bonding large to extra-large composite structures such as wind turbine rotor blades. It can also be used in other bonding applications that involve joining metal-metal, plastics-plastics, metal-plastics, wood-wood, wood-metal etc.

1. A recyclable epoxy adhesive system comprising:
a) 60-80% by wt. of an epoxy resin component having one or more di-functional epoxy resin; and
b) 20-40% by wt. of a curing agent component having one or more curing agent having at least one cleavable linkage.

2. The recyclable epoxy adhesive system as claimed in claim 1, wherein the epoxy resin is in the range of 65-85% by wt. of the total weight of the epoxy resin component.

3. The recyclable epoxy adhesive system as claimed in claim 1, wherein the epoxy resin is selected from the group consisting of Bisphenol A epoxy resin, Bisphenol F epoxy resin and a combination thereof.

4. The recyclable epoxy adhesive system as claimed in claim 1, wherein the epoxy resin component comprises mono or di-functional epoxidized reactive diluents selected from the group consisting of aliphatic epoxidized reactive diluents, aromatic epoxidized reactive diluents, non-reactive diluents, and a combination thereof.

5. The recyclable epoxy adhesive system as claimed in claim 4, wherein the diluent is selected from the group consisting of 1,4 butane diol diglycidyl ether, C 12-14 alkyl glycidyl ether, 1,6-hexanediol diglycidyl ether, cresyl glycidyl ether, polypropylene glycol and a combination thereof.

6. The recyclable epoxy adhesive system as claimed in claim 1, wherein the cleavable linkage is selected from the group consisting of an acetal linkage, a ketal linkage, a formal linkage, an orthoester, orthocarbonate linkage, and a siloxy linkage.

7. The recyclable epoxy adhesive system as claimed in claim 1, wherein the curing agent is an adduct of 2,2′ bis (2-aminoethoxy) propane, 2,2′ (2-amino propoxy) propane, or 2,2′ bis (2 amino butoxy) methyl silane.

8. The recyclable epoxy adhesive system as claimed in claim 1, wherein the curing agent is in the range of 70-90% by wt. of the total weight of the curing agent component.

9. The recyclable epoxy adhesive system as claimed in claim 1, comprising one or more component selected from the group consisting of an additive, a modifier, an accelerator, and a combination thereof.

10. The recyclable epoxy adhesive system as claimed in claim 9, wherein the one or more components are in the range of 10-30% by wt. of the total weight of recyclable adhesive system.

11. The recyclable epoxy adhesive system as claimed in claim 9, wherein the additive is selected from the group consisting of fumed silica, one or more pigment, one or more nature fiber, milled glass fiber, and a combination thereof.

12. The recyclable epoxy adhesive system as claimed in claim 9, wherein the modifier is selected from the group consisting of core shell rubber toughener, block copolymer, activated clay, silicone defoamer, epoxy silane, amino silanes, and a combination thereof.

13. The recyclable epoxy adhesive system as claimed in claim 9, wherein the accelerator is alkyl alkanolamine or derivative thereof.

14. An adhesive joint comprising two or more glass reinforced epoxy substrates, wherein the said glass reinforced epoxy substrates are joined together by the recyclable epoxy adhesive system as claimed in claim 1.

15. The adhesive joint as claimed in claim 14, wherein the adhesive joint can be recycled and de-bonded by low energy solvolysis process.
